(19) United States
(12) Patent Application Publication
(10) Pub. No.: US 2004/0068914 A1
(43) Pub. Date: Apr. 15, 2004

(54) Apparatus for ice fishing

(76) Inventors: Clark Wellard, Pocatello, ID (US); Paul Petersen, Idaho Falls, ID (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/187,637

(22) Filed: Jul. 1, 2002

Related U.S. Application Data
(63) Continuation-in-part of application No. 09/677,541, filed on Oct. 2, 2000, now Pat. No. 6,412,213.

(51) Int. Cl. A01K 77/00

(52) U.S. Cl. 43/12

(57) ABSTRACT

An ice fishing apparatus comprises a hand operated lever member or handle, an elongate edge link coupled between a proximal end of the handle and the back edge of a basket assembly, a center link comprised of one or more elongate members coupled between the distal end of the handle and one or more outer side edges of the basket assembly. The basket assembly may be comprised as a fishing net in which a net hoop and net are coupled to the distal ends of the linking members or a skimmer in which a skimming member is coupled to the linking members.

### CROSS-REFERENCED TO RELATED APPLICATIONS

This application is a continuation-in-part of and claims priority to co-pending U.S. patent application Ser. No. 09/677,541, filed on Oct. 2, 2000, now U.S. Pat. No. 6,412,213.

### BACKGROUND

1. Field of the Invention

The field of the invention relates generally to nets used for recreational fishing, and more specifically, to an apparatus for use when ice fishing to retrieve fish or remove ice from a hole that has been bored through a layer of ice that has formed on a lake or other body of water.

2. Background of the Invention

Ice fishing is becoming more and more popular among avid fisherman in the United States and Canada where the climate permits such activity during the winter months. Ice fishing has become a popular leisure activity for many men and women, commonly collectively referred to as anglers, who enjoy fishing during the warmer months and desire to fish when the weather turns cold and lakes and reservoirs freeze. Such fishing conditions, however, present their own unique problems and challenges.

A typical setup for an ice fishing angler includes a fishing pole to which a reel containing fishing line is attached. The line is fed through several eyelets attached to the length of the pole at spaced intervals. To the free end of the line, an angler will attach a lure or a hook and attach bait to the hook. In order to access the depths of a frozen pond or lake and thus to get the lure or bait to the fish, the angler must drill or have drilled a hole through the layer of ice. The hole must be of sufficient diameter to not only enter the bait or lure into the water but to retrieve any fish that may be caught. As such, typical hole diameters are 6, 8 or 10 inches. Once the hole is drilled through the ice, the hole must be cleaned of slush ice and then the angler can lower the bait or lure through the hole and into the water.

Once a fish is caught, the fish must be retrieved through the hole. Such a feat is often difficult as it is usually necessary to maintain proper tension on the line so that it does not exceed the breaking strength of the line or allow slack in the line which may allow the fish to free itself from the hook (especially when barbless hooks are used). In addition, once the fish leaves the water, the weight of the fish alone may exceed the breaking strength of the line. As such, anglers typically employ a retrieving device, such as a hand held net, to help retrieve the fish once it has been brought to within reaching distance of the angler. With respect to ice fishing, such nets must be configured to fit within the ice fishing hole. The hole itself is typically a cylindrically shaped bore extending one or more feet through the ice, depending on the thickness of the ice. As such, typical fishing nets which have sizes larger than the ice fishing hole are not useful as their size prevents them from being inserted into the hole. Furthermore, smaller nets that may be insertable into the ice fishing hole are not configured to fill the entire diameter of the hole to prevent a fish from falling between the wall of the ice fishing hole and the frame of the fishing net.

When ice fishing, an angler typically employs the use of a gas powered auger which is capable of boring a hole into the ice. As such, the hole will have a diameter corresponding to the diameter of the auger used. As discussed, such augers come standard in sizes ranging from about six inches in diameter to ten inches in diameter. Because the fishing hole often has a standard diameter and most anglers utilize a single auger having a particular size, it is possible to configure an ice fishing net for fitting within a particular diameter ice hole. For example, in U.S. Pat. No. 4,866,872, an apparatus for retrieving fish caught while ice fishing is disclosed in which a support member is mounted to a base member that is supported by the upper surface of an ice layer. The support member is extended and retracted through the ice hole and is operative to support a fish during such motion. An extension and retrieval mechanism, such as a slide rod interconnecting the base and support member whereby a fish caught on a fishing line may be maneuvered to the ice hole, and onto the support member and supported during upward movement through the ice hole. The support member may be pivoted out of alignment with the ice hole so as not to obstruct the lower opening thereto, and biased against the ice layer lower opening thereto, and biased against the ice layer lower surface in a ready position. An adjustable limit stop accommodates ice layers of varied thicknesses. The base member is preferably a circular collar, and the support member a pan element with drain holes. A major problem with the foregoing apparatus for retrieving fish while ice fishing is that the pan must be inserted below the ice layer and thus must include a sufficiently long handle to extend a required amount into the ice hole. Furthermore, the device can only be used in one hole as the device is mounted to the ice layer. Additionally, when used in lakes where the depth of the ice may be several feet, the size of the device may become cumbersome to maneuver and operate. Moreover, the ability of the fisherman to both hold tension in the fishing line while retrieving the fish and to maneuver the device is likely to be quite difficult.

A similar device is disclosed in U.S. Pat. No. 3,722,940 in which a stationary tube is attached along a side of the hole in the ice supports a rod having a handle at its upper end and a horizontal gate plate at its lower end. The rod is pivotable by the handle so as to swing the gate into a closed position at the bottom end of the hole, and the plate is then movable upwardly so to bring the fish to the top end of the hole in the ice. As with the aforementioned patent, the device of the 3,722,940 patent requires the device to be secured to the ice hole and extend to the bottom of the layer of ice.

Several other ice nets and ice skimmers have been developed that do not require the device to be lowered below the layer of ice. In the alternative, devices such as those disclosed in U.S. Pat. Nos. 3,289,850, 3,856,787 and 5,140,767 teach the use of a plate or scoop that can be actuated to a closed position once the device is lowered into the ice hole. U.S. Pat. No. 3,289,850 discloses an ice skimmer in which the skimmer is pivotally connect to a handle. Because it is often desirable to remove ice that forms in the ice hole, ice skimmers are used to keep the ice hole clear for easier fish removal. The skimmer shown in U.S. Pat. No. 3,289,850 is lowered into the ice hole with the skimmer lying against the handle. Once the skimmer is lowered and the handle is pulled upwardly out of the ice hole, it is intended that the skimmer will open to fill the hole to remove ice in the ice hole.

A similar device is shown in U.S. Pat. No. 3,857,787 in which an ice skimmer includes a mechanically actuated skimmer. The skimmer of U.S. Pat. No. 3,857,787 employs the use of an handle which can be actuated to manipulate the skimmer. Thus, once lowered into the ice hole in a vertical position, the skimmer can be rotated to a horizontal position and then lifted to remove the ice from the ice hole.

The ice net of U.S. Pat. No. 5,140,767 operates similarly to the skimmer of U.S. Pat. No. 3,857,787 in that an actuatable handle is utilized to close the ice net once a fish is positioned above a scoop in the ice hole. In the open position (i.e., when the scoop is in a vertical position), the scoop will necessary obstruct a substantial portion of the ice hole. That is, for a scoop having a diameter close to the diameter of the ice hole, the scoop will necessarily be positioned away from the side wall of the ice hole thus reducing the effective diameter of the hole as the ice net is lowered pass the fish. As the fish is typically moving to try to free itself, the lower end of the ice scoop can actually impinge upon the fish at the point of the hook and dislodge the hook from the fish thus freeing the fish.

Accordingly, it would be advantageous to provide an ice fishing net that does not have to be inserted into an ice hole completely through the layer of ice to be operable. It would also be advantageous to provide an ice fishing net that provides little obstruction in the ice hole when inserted therein so that the net can pass by a fish in an ice hole held on a line by an angler without dislodging the fish from the line. It would still be a further advantage to provide an ice fishing net that is operable with one hand so that the angler can hold a fishing pole with one hand and maneuver and operate the fishing net with the other hand. These and other advantages will become apparent from a reading of the following description of the preferred embodiments of an ice fishing net in accordance with the principles of the present invention.

### SUMMARY OF THE INVENTION

Accordingly, the present invention provides an ice fishing apparatus that is capable of retrieving a fish from a hole that has been formed in the ice by an angler when ice fishing. The ice fishing apparatus is configured so that it does not substantially obstruct the ice hole when used by an angler to retrieve a fish from the ice hole when ice fishing. The ice fishing apparatus can be operated with one hand by an angler to retrieve a fish or ice from the ice hole when ice fishing.

The ice fishing apparatus of the present invention is simple to operate and relatively lightweight and can enter the hole while the fish is in the hole, bypass the fish and prevent the fish from exiting the bottom of the hole. In addition, the ice fishing apparatus of the present invention can be effectively used and operated without requiring the angler to put his or her hands in the water or lay his or her pole down.

The ice fishing apparatus of the present invention comprises a hand operated lever member or handle, an elongate edge link coupled between a proximal end of the handle and the back edge of a net hoop, a center link comprised of a pair of elongate members coupled between the distal end of the handle and the outer side edges of the net hoop. A net is coupled to the net hoop.

The handle is comprised of a “J” shaped member with the end of its long side (i.e., the proximal end) attached to the edge link and the end of its short side (i.e., the distal end) attached to the center link. The “J” shape of handle allows a user to raise and lower the center link relative to edge link with one hand, thus, rotating the net hoop from a substantially horizontal position to a substantially vertical position.

The net hoop has a trapezoid or arch shaped configuration when viewed from its right or left side. In addition, the center link has an angled portion coupled to the net hoop with the angle portion extending toward the back edge of the net hoop. The configuration of the center link and the net hoop allows the user to return the net hoop to a substantially horizontal position from a substantially vertical position by a simple upward rotation of the handle relative to the edge link. That is, the angled portion of the center link and the arched shape of the net hoop causes the pivot point between the center link and the net hoop to be outwardly spaced from the pivot point of the edge link and the net hoop when the net hoop is in a substantially vertical position. By keeping these two pivot points horizontally spaced with the center link/net hoop pivot point in front of the pivot point for the edge link and net hoop, the net hoop can be easily rotated about the edge link.

The net hoop has a crescent shape when viewed from the front of the fishing net. The crescent shape has a radius configured to substantially match the diameter of the ice hole being fished. That is, the radius of the net hoop may be four inches or five inches to match a typical eight or ten inch diameter ice hole. As the-net hoop is rotated downwardly relative to the edge link, the curvature of the net hoop is such that the hoop will lie along or proximate to the inner wall of the ice hole. As such, the net hoop will not obstruct the ice hole to any appreciable extent so as to allow an angler to pull a fish into the ice hole past the net hoop and rotate the net hoop to a substantially horizontal orientation once the fish has been past the net hoop.

The net is attached to the net hoop and thus suspended therefrom. The net freely hangs from the net hoop and is sized for receiving an supporting a fish therein as the net is removed from an ice hole. The net may be formed from any of the various mesh or net materials known in the art of fishing.

In another embodiment, the net portion of the ice fishing apparatus may be replaced with an ice skimming attachment. The ice skimming attachment essentially replaces the net hoop and net of the above-described ice fishing net. Thus, the configuration of the handle and link members can remain the same with the skimming attachment configured to be interchangeable with the net hoop.

The skimming attachment is comprised of a disk-shaped member having holes or slits formed therein that allow water to drain through the skimming attachment while holding ice and ice slush on its top surface. The skimming attachment has a convex shape to provide a scoop for holding the ice and ice slush on its top surface as the ice skimmer is retrieved from the ice hole.

Because the ice skimmer is used to remove ice and ice slush from the ice hole when a fish is not present in the ice hole, the center link can be coupled to the center of the skimming attachment, rather than its side edges. Thus, the center link may comprise a single elongate link member coupled between the handle and the ice skimming attachment.

Tabs attached to the appropriate locations of the skimming attachment may be employed to attache the skimming attachment to the edge and center links in a hinge-like fashion to allow the skimming attachment to pivot relative to the link members to rotate the skimming attachment from a substantially vertical orientation when being inserted into an ice hole to a substantially horizontal orientation when below the water surface to retrieve ice and ice slush from the ice hole.

To utilize the ice skimmer when fishing without causing the anglers fishing line to be cut, the skimming attachment may include a radially extending slot therein that is open at an outer edge-of the skimming attachment. Thus, as the skimming attachment is oriented by the user from a vertical to a horizontal position, the fishing line can enter the slot and thus not be pinched between the outer surface of the skimming attachment and the inner wall of the ice hole.

Whether utilized as an ice fishing net or an ice fishing skimmer the ice fishing apparatus of the present invention can be operated with one hand by grasping the handle and rotating the handle relative to the edge link. When the basket (whether a net or an ice skimmer) of the ice fishing apparatus is in a substantially horizontal orientation and the handle is downwardly pivoted relative to the edge link, the basket swings down to a substantially vertical orientation for insertion into the ice hole. Rotating the handle back to its starting position relative to the edge link causes the basket to move back to a substantially horizontal position. Thus, the ice fishing apparatus of the present invention can be operated with one hand causing the basket to move between a first position and a second position and back again as desired.

### BRIEF DESCRIPTION OF THE ILLUSTRATIONS

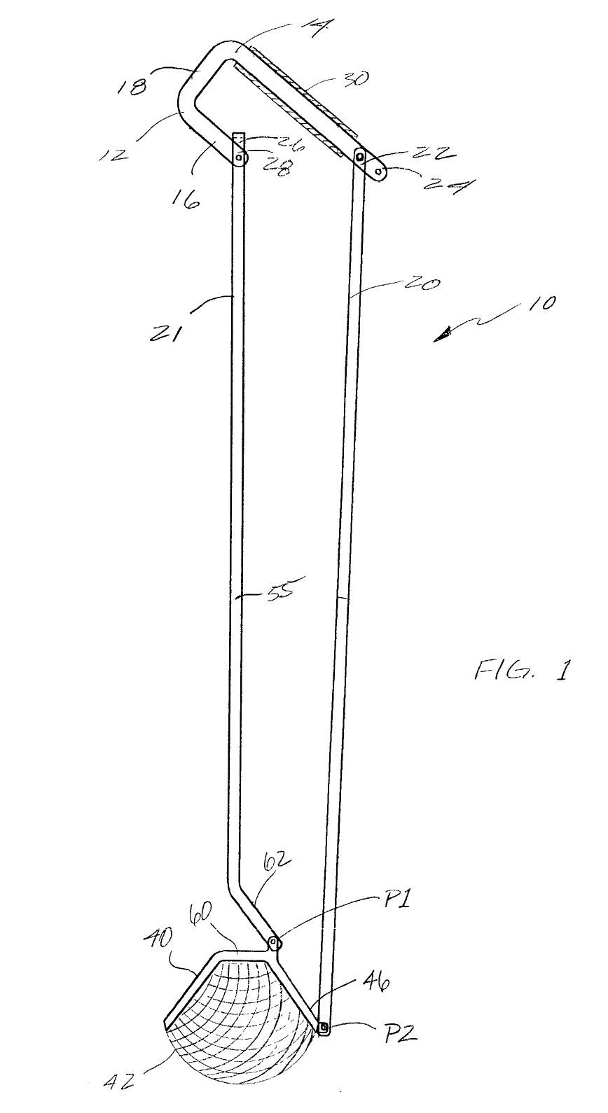

FIG. 1 is a side view of a first embodiment of an ice fishing apparatus in accordance with the principles of the present invention, in this example configured as an ice fishing net;

FIG., 2 is a top view of a net hoop utilized in the ice fishing net of FIG. 1;

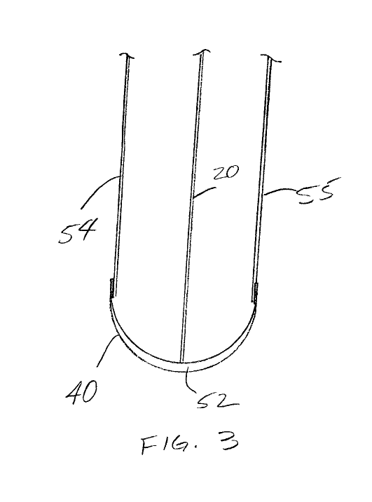

FIG. 3 is a partial front view of the net hoop and associated linking members of the ice fishing net shown in FIG. 1;

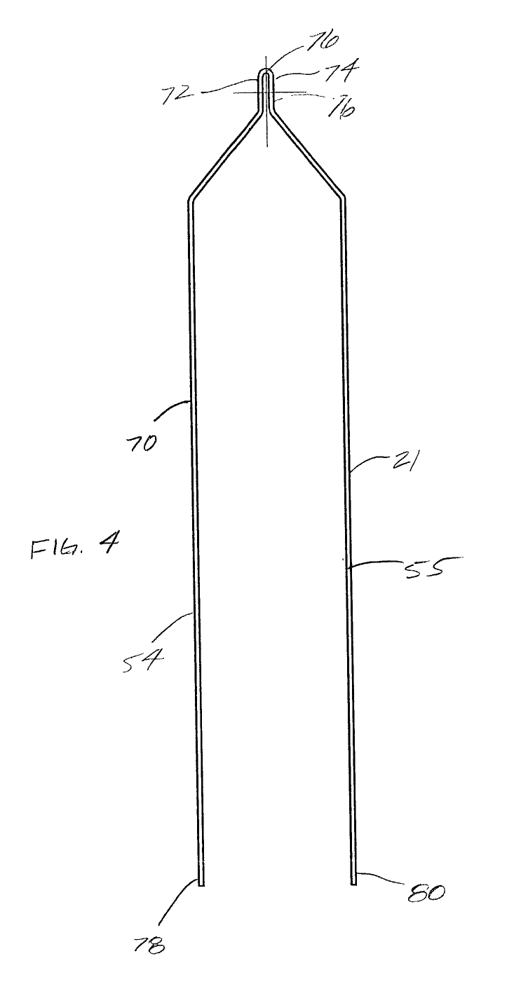

FIG. 4 is a front view of a center linking member of the ice fishing net of FIG. 1;

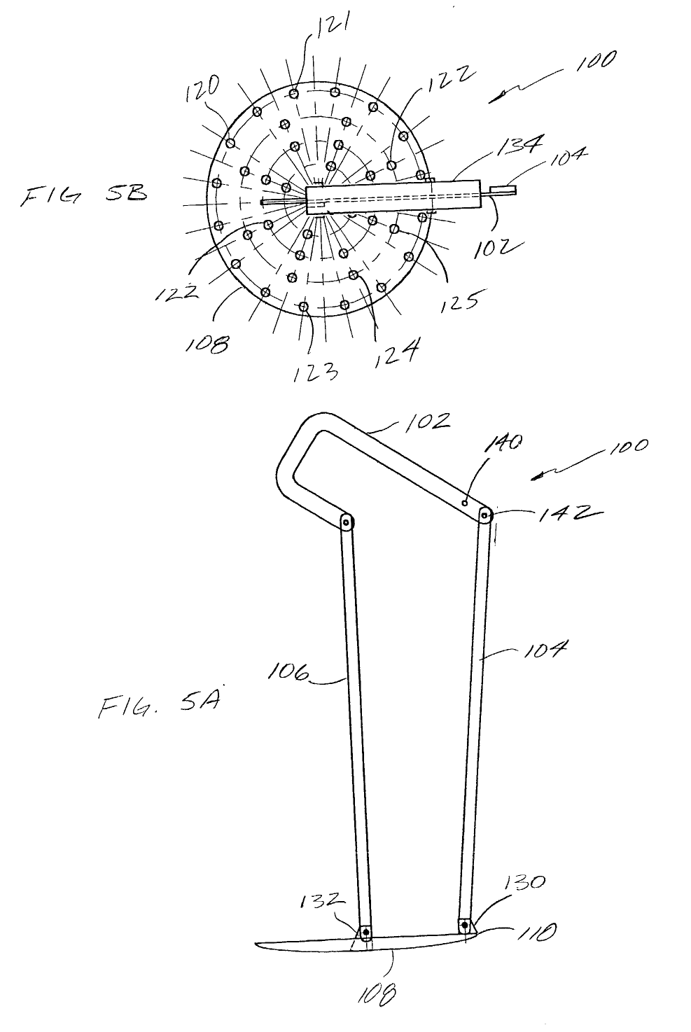

FIG. 5A is a side view of a second embodiment of an ice fishing apparatus in accordance with the principles of the present invention, in this example configured as an ice fishing skimmer; and

FIG. 5B is a top view of the ice fishing skimmer illustrated in FIG. 5A.

### DETAILED DESCRIPTION OF THE INVENTION

FIG. 1 illustrates a first embodiment of an ice fishing apparatus, generally indicated at 10 in accordance with the principles of the present invention. The ice fishing apparatus 10 in this example is configured as an ice fishing net for retrieving a fish from a circular ice hole that has been formed through a layer of ice on a lake or other frozen body of water. The ice fishing net 10 is comprised of a handle member 12 having a “J”-shaped configuration. The handle member 12 is comprised of an elongate first portion 14 having a length that is longer than an elongate second portion 16 interconnected by a spacing portion 18 at the distal ends of the first and second portions 14 and 16. Likewise, the handle member 12 could have an “L”-shaped configuration.

A first elongate linking member 20 is rotatable coupled at a proximal end 22 thereof to the proximal end 24 of the first portion 14 of the handle member 12. A second elongate linking member 21 is rotatably coupled at its proximal end 26 to the proximal end of the second portion 16 of the handle member 12. The linking members 20 and 21 are attached to the handle member 12 with fasteners known in the art, such as threaded fasteners (e.g., nuts and bolts), military pins that have retractable projections typically formed from steel spheres (e.g., small ball bearings) that can be actuated in and out to allow quick removal and re-attachment of the pins, cotter-type pins, rivets, and the like.

A handle cover 30, as shown in cross-section, may be fitted over the handle portion 14 for facilitating grasping by a user. The handle cover 30 may comprise an elongate section of plastic pipe or tubing, for example. The handle 12 is comprised of a flat section of metal with holes drilled there through at the locations shown for proper attachment of the linking members 20 and 21.

The linking members 20 and 21 are coupled to a net hoop 40 in a similar pivoting fashion as the attachment of the linking members 20 and 21 to the handle 12. A net 42 is coupled to the net hoop as by overlapping the net hoop 40 or other methods of attaching such nets known in the art. The net hoop 40 is shown in a first or substantially horizontal position for retrieving a fish such that the net 42 hangs below the net hoop 40.

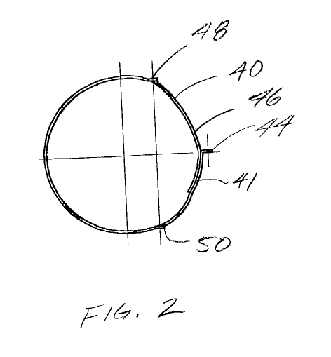

As further illustrated in FIG. 2, the net hoop 40 is configured to have a substantially circular configuration when viewed from the top of the net hoop 40 so as to circumferentially fit within a given size ice hole. Thus, the net hoop 40 is configured for use with a particularly sized ice hole. Because most ice holes are formed by use of an auger having a particular diameter, the net hoop 40 can be configured for a particular auger. For example, most augers used for ice fishing form an approximately eight inch or ten inch diameter ice hole. Thus, a matching net hoop 40 would be slightly smaller than eight or ten inches depending on the size of the ice hole to allow the ice hoop to be easily inserted and removed from a given sized ice hole while substantially filling the circumference of the ice hole. The net hoop 40 is comprised of a single elongate section of material, such as flat stock aluminum that is formed in a circular shape and overlapped along a portion 41 thereof and attached to itself. A rear edge link tab 44 is attached to the back edge 46 of the net hoop 40 and a pair of center link tabs 48 and 50 are attached to the net hoop 40 on opposite sides of the net hoop and circumferentially spaced approximately equal distances from the rear edge link tab 44.

The net hoop 40 when viewed from the front, as shown in FIG. 3, has a crescent or semicircular shape with a radius sized to be slightly smaller than the radius of the ice hole. The shape of the net hoop 40 is such that when the front edge 52 of the net hoop 40 is lowered with the center link arms 54 and 55 relative to the rear edge link 30 until the net hoop 40 is in a substantially vertical position, the net hoop 40 will lie against the inner wall of the ice hole so as to provide little obstruction of the ice hole. By placing the net hoop 40 in this “ready” position, the net hoop 40 can be lowered into the ice hole past the fishing line and fish attached thereto without interfering with the fishing or the fish as the net hoop will effectively slide along the surface of the ice hole. The net hoop 40 can then be rotated to a horizontal or “retrieving” position and lifted to capture the fish in the net 42 (see FIG. 1) and remove the fish from the ice hole.

Referring again to FIG. 1, the net hoop 40 has a trapezoidal or arch shaped configuration when viewed from its side 60. In addition, the arms (arm 55 of which is visible) of the center link 21 have an angled portion 62 coupled to the net hoop 40 with the angled portion 62 extending toward the back edge of the net hoop 40. The configuration of the center link 21 and the net hoop 40 allows the user to return the net hoop 40 to a substantially horizontal position, as shown, from a substantially vertical position by a simple upward rotation of the handle 12 relative to the edge link 20. That is, the angled portion 62 of the center link 21 and the arched shape of the net hoop 40 causes the pivot point P1 between the center link 21 and the net hoop 40 to be effectively outwardly spaced from the pivot point P2 of the edge link 20 and the net hoop 40 when the net hoop is in a substantially vertical position. By keeping these two pivot points P1 and P2 horizontally spaced with the center link/net hoop pivot point P1 in front of the pivot point P2 for the edge link 20 and net hoop 40, the net hoop 40 can be easily rotated about the edge link 20 between horizontal and vertical positions.

As shown in FIG. 4, the center link 21 is comprised of a single elongate member 70 formed of flat aluminum stock formed into a “Y” shaped configuration. The center link 21 has a left arm portion 54 and a right arm portion 55 coupled at their proximal ends 72 and 74, respectively, with a bend 76. The proximal ends 72 and 74 of the arm portions 54 and 55 lie in close parallel proximity to form an attachment portion 76 at the proximal ends 72 and 74 for attaching the center link 21 to the handle 12 (see FIG. 1).

The right and left arm portions 54 and 55 then angle outwardly from the attachment portion 76 until they are spaced apart approximately equal to the diameter of the net hoop 40 (see FIG. 3). The distal ends 78 and 80 of the arm portions 54 and 55 are configured with transversely extending bores for pivotal attachment to the tabs of the net hoop 40. It should be noted that while illustrated as a single section of material, the center link 21 could be comprised of several individual components joined together by mechanical, chemical or metal bonding attachment to form the desired shape of the center link 21.

Referring now to FIGS. 5A and 5B, there is shown an ice fishing apparatus, generally indicated at 100, in accordance with the principles of the present invention. In this example, the ice fishing apparatus comprises an ice skimmer for removing ice and slush from an ice hole after the ice hole has been drilled or otherwise formed. The ice skimmer 100 is comprised of a handle 102 having a configuration similar to the handle 12 of FIG. 1. The handle is pivotally coupled to an edge link 104 and a center link 106. The edge link 104 is coupled to a skimming member 108 proximate a back edge 110 thereof. The center link 106 is also coupled to the skimming member 108 proximate a center thereof.

The skimming member 108 is comprised of a saucer shaped member having a concave configuration for forming a basket to remove ice from an ice hole. The skimming member is generally circular in shape with a plurality of holes, such as holes 120-125 formed therein for allowing water to flow through the skimming member 108 while capturing and supporting ice and slush therein. Tabs 130 and 132 are attached to the skimming member 108 for attaching to the linking members 104 and 106, respectively. Because there is no concern about passing the skimming attachment around a fish within the ice hole, as with the ice net of the present invention, the center link 106 can be coupled to the center of the skimming member 108 and the skimming member 108 is not configured to lie against the inner wall of the ice hole when the skimming member is lowered to a vertical orientation.

Because the skimming member substantially fills the diameter of the ice hole when positioned in an ice removal position as shown, the ice skimmer 100 removes substantially all of the loose ice within an ice hole in one scoop. By tilting the skimming member down through downward rotation of the handle relative to the edge link 104, the skimming member 108 can be lowered into the water in a substantially vertical direction to allow ice in the ice hole to pass around the skimming member. When the skimming member 108 passes the layer of loose ice in the ice hole, the handle can be rotated upwardly as shown and the skimming device lifted from the ice hole, thus removing the loose ice from the ice hole. Because the center link 106 is positioned at or near the center of the skimming member 108, the weight of the loose ice on the skimming member 108 can be adequately supported without damaging the skimming member, the handle 102 or the linking member 104 and 106.

The link members 104 and 106 are generally shorter than the corresponding link members of the ice fishing version as it its not necessary to position the skimmer deep into the ice hole to remove the loose ice. Indeed, it is easy to remove the loose ice by inserting the skimming member 108 a few inches into the ice hole, remove some of the loose ice, allowing more ice to float to the top and removing more loose ice with several repeated insertions of the skimming member 108 into the ice hole.

As shown in FIG. 5B, the handle 102 may be covered with a gripping member 134 to make the handle 102 more comfortable to grasp and operate.

It is also contemplated in accordance with the principles of the present invention that the ice fishing net version and the ice skimmer version of the ice fishing apparatus of the present invention be made with interchangeable components. Thus, as shown in FIG. 5A, the handle 102 is provided with a pair of holes 140 and 142 with the hole 140 used to attach to the edge link 104 for the ice skimmer and the hole 142 use for attaching the edge link 20 for the ice fishing net. With the ice skimmer, attaching the edge link to the hole 142 causes the link members 104 and 106 to be non-parallel when the skimmer is in a horizontal or ready position. This non-parallel arrangement, allows the handle 102 to freely rotate the skimming member 108 between horizontal and vertical positions without binding. That is, the center link 106 is caused to pull the tab 132 forward relative to the tab 130 even when the skimming member 108 is in a substantially vertical orientation. This allows the skimming member 108 to easily rotate back to a horizontal position when the handle 102 is upwardly rotated.

With such a configuration, the same handle 102 could be used for either the net or the skimmer by a quick switch of the handle 102. This is particularly useful to save materials and thus the cost that would otherwise be imposed if the net and skimmer were sold completely separately.

Another option for interchangeability would be to provide a pair of edge tabs on the skimming attachment 108 similar to the edge tabs 48 and 50 attached to the net hoop 40 as shown in FIG. 2. By doing so, the net hoop and skimming attachment could be swapped utilizing the same center and edge links to rotate the appropriate attachment, commonly referred to herein as the “basket”. By employing quick release fasteners, such as military pins, to the connections between the links and the basket, the same handle and link members could be utilized for both the net version and the skimming version.

While the ice fishing apparatus of the present invention has been illustrated in certain embodiments to illustrate what is believed to be the best mode of the invention, it is contemplated that upon review of the present invention, those of skill in the art will appreciate that various modifications and combinations may be made to the present embodiments without departing from the spirit and scope of the invention as recited in the claims. As such, the claims provided herein are intended to cover such modifications and combinations and all equivalents thereof. Therefore, reference herein to specific details of the illustrated embodiments is by way of example and not by way of limitation.

What is claimed is:

1. An fishing apparatus, comprising:
a handle having a proximal end and a distal end;
a basket having an outer perimeter;
a first linking member pivotally coupled between said handle and said basket proximate said outer perimeter; and
a second linking member pivotally coupled between said handle and said basket and spaced from said first linking member.

2. The apparatus of claim 1, wherein said handle has a J-shaped configuration, said first linking member coupled to said proximal end of said handle and said second linking member coupled to said distal end of said handle.

3. The apparatus of claim 1, wherein said handle has an L-shaped configuration.

4. The apparatus of claim 1, further including a handle cover positioned over at least a portion of said handle.

5. The apparatus of claim 1, wherein said basket comprises a net hoop and net coupled thereto.

6. The apparatus of claim 5, wherein said first linking member is coupled between a proximal end of said handle and a back portion of said net hoop.

7. The apparatus of claim 6, wherein said second linking member comprises a pair of link arms each having proximal ends and distal ends, said proximal ends of said link arms coupled to said distal end of handle and said distal ends coupled to said net hoop on opposite sides thereof, each being substantially equally spaced from said first linking member.

8. The apparatus of claim 5, wherein said net hoop is arch-shaped when viewed from a left side thereof.

9. The apparatus of claim 8, wherein said net hoop is curved to substantially match the radius of a particularly sized ice hole.

10. The apparatus of claim 7, wherein rotation of said handle downwardly relative to said first linking member rotates said net hoop from a first, substantially horizontal position to a second, substantially vertical position.

11. The apparatus of claim 1, wherein said basket comprises a skimmer.

12. The apparatus of claim 11, wherein said first linking member is coupled between a proximal end of said handle and a back portion of said skimmer.

13. The apparatus of claim 12, wherein said second linking member is coupled between a distal end of said handle and proximate a center of said skimmer.

14. The apparatus of claim 11, wherein said skimmer is comprised of a dish-shaped member having a concave top surface.

15. The apparatus of claim 13, wherein rotation of said handle downwardly relative to said first linking member rotates said skimmer from a first, substantially horizontal position to a second, substantially vertical position.

16. An ice fishing net, comprising:
a handle having a proximal end and a distal end;
a net hoop having an outer perimeter;
a net coupled to said net hoop;
a first linking member coupled between a proximal end of said handle and a back portion of said net hoop; and
a second linking member comprising a pair of link arms each having proximal ends and distal ends, said proximal ends of said link arms coupled to said distal end of handle and said distal ends of said link arms coupled to said net hoop on opposite sides thereof, each being spaced from said first linking member.

17. The net of claim 16, wherein said net hoop is arch-shaped when viewed from a left side thereof.

18. The net of claim 16, wherein said net hoop is curved to substantially match the radius of a particularly sized ice hole.

19. The net of claim 16, wherein rotation of said handle downwardly relative to said first linking member rotates said net hoop from a first, substantially horizontal position to a second, substantially vertical position.

20. An ice fishing skimmer, comprising:
a handle having a proximal end and a distal end;
a skimming member having an outer perimeter;
a first linking member coupled between said proximal end of said handle and a back portion of said skimming member; and
a second linking member coupled between said distal end of said handle and proximate a center of said skimming member.

21. The skimmer of claim 20, wherein said skimming member is comprised of a dish-shaped member having a concave top surface.

22. The skimmer of claim 20, wherein rotation of said handle downwardly relative to said first linking member rotates said skimming member from a first, substantially horizontal position to a second, substantially vertical position.
